(19) United States
(12) Patent Application Publication
(10) Pub. No.: US 2024/0120612 A1
(43) Pub. Date: Apr. 11, 2024

(54) BATTERY MODULE, AND BATTERY PACK AND VEHICLE INCLUDING THE SAME

(71) Applicant: LG ENERGY SOLUTION, LTD., Seoul (KR)

(72) Inventors: Jin-Yong PARK, Daejeon (KR); Ho-June CHI, Daejeon (KR); Jhin-Ha PARK, Daejeon (KR); Jae-Min YOO, Daejeon (KR)

(73) Assignee: LG ENERGY SOLUTION, LTD., Seoul (KR)

(21) Appl. No.: 18/275,561

(22) PCT Filed: Apr. 27, 2022
(86) PCT No.: PCT/KR2022/006050

§ 371 Date: Aug. 2, 2023

(30) Foreign Application Priority Data
Jun. 7, 2021 (KR) 10-2021-0073746

(51) Int. Cl. H01M 50/383; B60L 50/64; H01M 50/211; H01M 50/258; H01M 50/358

(52) U.S. Cl. CPC H01M 50/383; B60L 50/64; H01M 50/211; H01M 50/258; H01M 50/358; H01M 2220/20

(57) ABSTRACT

A battery module includes a battery cell assembly including a plurality of battery cells; a module housing configured to accommodate the battery cell assembly; and an end cover unit coupled to the module housing. When a flame or gas is generated inside the module housing, the end cover unit is configured to disperse the flame or gas and guide the flame or gas in a predetermined direction.

### TECHNICAL FIELD

The present application claims priority to Korean Patent Application No. 10-2021-0073746 filed on Jun. 7, 2021 in the Republic of Korea, the disclosures of which are incorporated herein by reference.

The present disclosure relates to a battery module, and a battery pack and a vehicle including the same.

### BACKGROUND ART

Secondary batteries which are highly applicable to various products and exhibit superior electrical properties such as high energy density, etc. are commonly used not only in portable devices but also in electric vehicles (EVs) or hybrid electric vehicles (HEVs) driven by electrical power sources. The secondary battery is drawing attentions as a new energy source for enhancing environment friendliness and energy efficiency in that the use of fossil fuels can be reduced greatly and no byproduct is generated during energy consumption.

Secondary batteries widely used at the preset include lithium ion batteries, lithium polymer batteries, nickel cadmium batteries, nickel hydrogen batteries, nickel zinc batteries and the like. An operating voltage of the unit secondary battery cell, namely a unit battery cell, is about 2.5V to 4.5V. Therefore, if a higher output voltage is required, a plurality of battery cells may be connected in series to configure a battery pack. In addition, depending on the charge/discharge capacity required for the battery pack, a plurality of battery cells may be connected in parallel to configure a battery pack. Thus, the number of battery cells included in the battery pack may be variously set according to the required output voltage or the demanded charge/discharge capacity.

Meanwhile, when a plurality of battery cells are connected in series or in parallel to configure a battery pack, it is common to configure a battery module composed of at least one battery cell first, and then configure a battery pack or a battery rack by using at least one battery module and adding other components. Meanwhile, one or more battery racks as above are provided to configure an energy storage system as an energy source.

A conventional battery module is generally configured to include a plurality of battery cells and a module housing for accommodating the plurality of battery cells. In the conventional battery module, when a flame or gas is generated in at least one battery cell due to an abnormal situation inside the module housing, most of the flame or gas stays in the module housing. Accordingly, there is a problem in that the temperature of adjacent battery cells is increased by the flame or gas in the module housing, which may lead to thermal runaway of all battery cells and further explosion of the battery module.

Therefore, it is required to find a way to provide a battery module that may prevent thermal runaway when a flame or gas is generated inside the module housing, and a battery pack and a vehicle including the battery module.

### DISCLOSURE

### Technical Problem

The present disclosure is directed to providing a battery module, which may prevent thermal runaway when a flame or gas is generated inside a module housing, and a battery pack and a vehicle including the battery module.

### Technical Solution

In one aspect of the present disclosure, there is provided a battery module, comprising: a battery cell assembly including a plurality of battery cells; a module housing configured to accommodate the battery cell assembly; and an end cover unit coupled to the module housing, wherein when a flame or gas is generated inside the module housing, the end cover unit is configured to disperse the flame or gas and guide the flame or gas in a predetermined direction.

The end cover unit may be provided at both ends of the module housing and guide the flame or gas in the module housing to an upper side of both ends of the module housing.

The end cover unit may include a cover body mounted at both ends of the module housing, and the cover body may have a discharge hole that is opened toward an upper side of the cover body to discharge the flame or gas.

The end cover unit may include a first dispersion guider provided to the cover body and configured to primarily disperse the flame or gas; and a second dispersion guider disposed to face the first dispersion guider and configured to secondarily disperse the flame or gas.

The first dispersion guider may be disposed to face the battery cell assembly.

The first dispersion guider may be provided as a mesh member made of a metal material.

The second dispersion guider may be provided as at least one second dispersion guider or a plurality of second dispersion guiders and be configured to communicate with the discharge hole.

The second dispersion guider may be provided to have a rib structure of a whirlwind shape.

The end cover unit may include a directional guider disposed to face the second dispersion guider and configured to guide a discharge direction of the flame or gas.

The directional guider may be configured to communicate with the discharge hole and guide the flame or gas toward the discharge hole.

The directional guider may include at least one offset fin.

In addition, the present disclosure provides a battery pack, comprising: at least one battery module according to the above embodiments; and a pack case configured to package the at least one battery module.

Moreover, the present disclosure provides a vehicle, comprising at least one battery pack according to the above embodiment.

### Advantageous Effects

According to various embodiments as described above, it is possible to provide a battery module, which may prevent thermal runaway when a flame or gas is generated inside a module housing, and a battery pack and a vehicle including the battery module.

### DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a diagram for illustrating a battery module according to an embodiment of the present disclosure.

FIG. 2 is an exploded perspective view showing the battery module of FIG. 1.

FIG. 3 is a diagram for illustrating an end cover unit of the battery module of FIG. 2.

FIG. 4 is an exploded perspective view showing the end cover unit of FIG. 3.

FIGS. 5 to 9 are diagrams for illustrating a mechanism for dispersing and guiding a flame or gas when the flame or gas is generated in the battery module of FIG. 1.

FIG. 10 is a diagram for illustrating a battery pack according to an embodiment of the present disclosure.

FIG. 11 is a diagram for illustrating a vehicle according to an embodiment of the present disclosure.

### BEST MODE

The present disclosure will become more apparent by describing in detail the embodiments of the present disclosure with reference to the accompanying drawings. It should be understood that the embodiments disclosed herein are illustrative only for better understanding of the present disclosure, and that the present disclosure may be modified in various ways. In addition, for ease understanding of the present disclosure, the accompanying drawings are not drawn to real scale, but the dimensions of some components may be exaggerated.

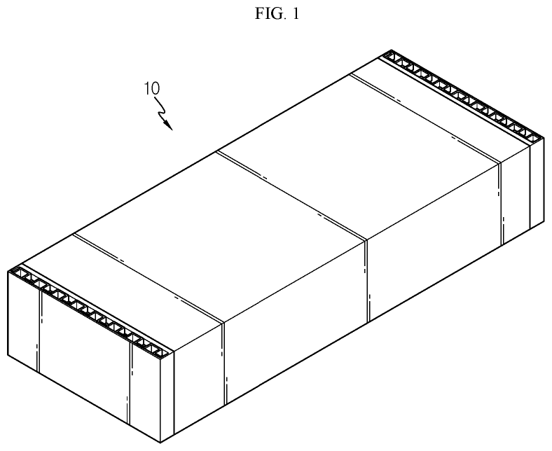

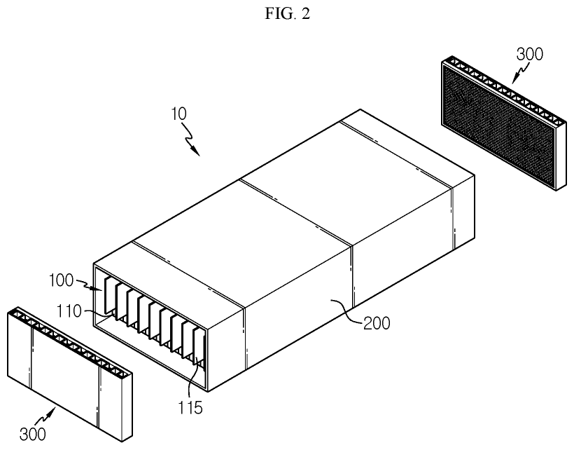

FIG. 1 is a diagram for illustrating a battery module according to an embodiment of the present disclosure, and FIG. 2 is an exploded perspective view showing the battery module of FIG. 1.

Referring to FIGS. 1 and 2, the battery module 10 may include a battery cell assembly 100, a module housing 200, and an end cover unit 300.

The battery cell assembly 100 may include a plurality of battery cells 110.

The plurality of battery cells 110 are secondary batteries, and may be provided as pouch-type secondary batteries, rectangular secondary batteries or a cylindrical secondary batteries. Hereinafter, in this embodiment, it will be described that the plurality of battery cells 110 are pouch-type secondary batteries.

The plurality of battery cells 110 may be stacked to be electrically connected to each other. Each of the plurality of battery cells 110 may include an electrode assembly, a battery case for accommodating the electrode assembly, and a pair of electrode leads 115 protruding out of the battery case and connected to the electrode assembly. Here, the pair of electrode leads 115 may be disposed to face the end cover unit 300, explained later.

The module housing 200 may accommodate the battery cell assembly 100. To this end, an accommodation space capable of accommodating the battery cell assembly 100 may be provided in the module housing 200.

The end cover unit 300 is coupled to the module housing 200, and when a flame or gas is generated inside the module housing 200, the end cover unit 300 may disperse the flame or gas to be guided in a predetermined direction.

The end cover unit 300 may be provided as a pair. Specifically, the pair of end cover units 300 are provided at both ends of the module housing 200, and may guide the flame or gas in the module housing 200 to an upper side of both ends of the module housing 200.

Hereinafter, the end cover unit 300 according to this embodiment will be described in more detail.

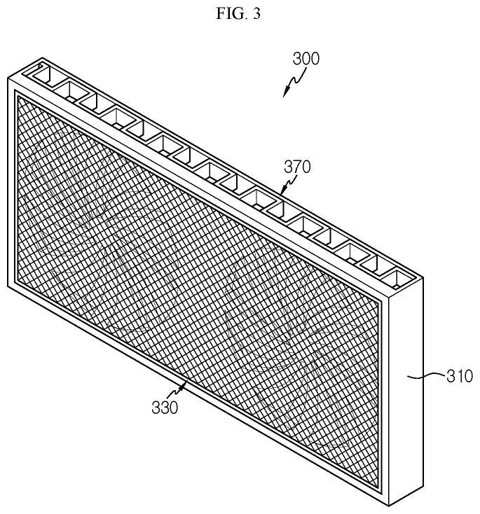

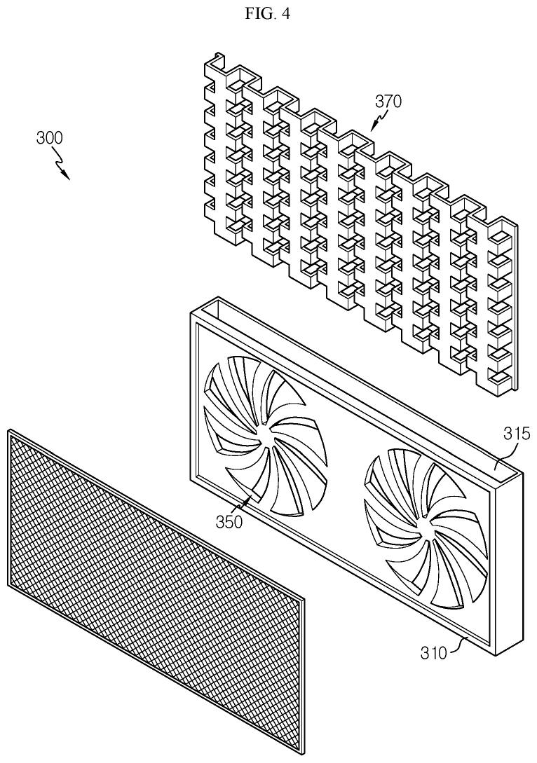

FIG. 3 is a diagram for illustrating an end cover unit of the battery module of FIG. 2, and FIG. 4 is an exploded perspective view showing the end cover unit of FIG. 3.

Referring to FIGS. 3 and 4, the end cover unit 300 may include a cover body 310, a first dispersion guider 330, a second dispersion guider 350, and a directional guider 370.

The cover body 310 is mounted at both ends of the module housing 200, respectively, and may be provided in a shape capable of covering both ends of the module housing 200, respectively. The cover body 310 may have a discharge hole 315 that is opened toward an upper side of the cover body to discharge the flame or gas.

The first dispersion guider 330 is provided to the cover body 310, and may primarily disperse the flame or gas. The first dispersion guider 330 may be disposed to face the battery cell assembly 100. Specifically, the first dispersion guider 330 may be disposed to face the electrode leads 115 of the battery cells 110.

The first dispersion guider 330 may be provided as a mesh member made of a metal material, and may be provided on one surface of the cover body 310 facing the battery cell assembly 100.

The second dispersion guider 350 is provided to the cover body 310, is disposed to face the first dispersion guider 350, and may secondarily disperse the flame or gas.

The second dispersion guider 350 is integrally formed with the cover body 310, is provided as at least one second dispersion guider or a plurality of second dispersion guiders, and may communicate with the discharge hole 315. Hereinafter, in this embodiment, the second dispersion guider 350 will be described as being provided as a pair.

The pair of second dispersion guiders 350 may be provided to have a rib structure of a whirlwind shape. Accordingly, the pair of second dispersion guiders 350 may absorb the flame length by rotating to guide and disperse the flame or gas.

The directional guider 370 is disposed to face the second dispersion guider 350, and may guide a discharge direction of the flame or gas. The directional guider 370 may be inserted into the cover body 310, communicate with the discharge hole 315, and guide the flame or gas toward the discharge hole 315.

The directional guider 370 may include at least one offset fin. Moreover, the directional guider 370 may be formed in a louver-shaped fin structure. In addition, the directional guider 370 may form an uneven structure along the width direction of the cover body 310.

The directional guider 370 may allow the flame or gas that passing through the second dispersion guider 350 to flow toward the discharge hole 315, reduce the gas pressure by the differential pressure and further disperse the flame or gas, and lower the temperature of the flame or gas even further.

Hereinafter, the mechanism for dispersing and guiding a flame or gas when the flame or gas is generated in the battery module 10 according to this embodiment will be described in more detail.

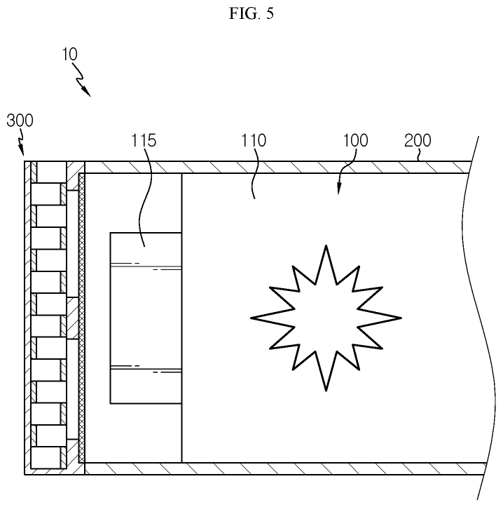

FIGS. 5 to 9 are diagrams for illustrating a mechanism for dispersing and guiding a flame or gas when the flame or gas is generated in the battery module of FIG. 1.

Referring to FIG. 5, due to overheating caused by an abnormal situation of at least one battery cell 110 among the battery cells 110 of the battery cell assembly 100 of the battery module 10, a flame or gas may be generated in the battery cell 110 where the abnormal situation occurs.

Here, if the flame or gas continuously stays inside the module housing 200, the flame or gas may increase the temperature of adjacent battery cells 110, which may lead to thermal runaway and further explosion of the battery module 10.

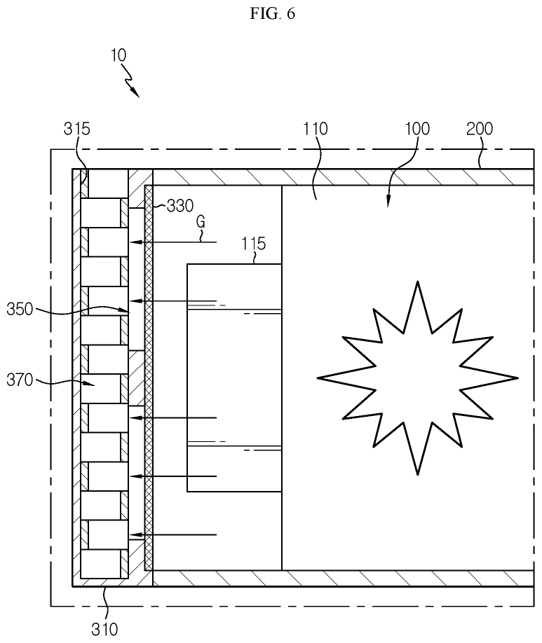

Referring to FIG. 6, when such an abnormal situation occurs, the flame or gas G in the battery cell 110 where an abnormal situation occurs may preferentially pass through the first dispersion guider 330 of the end cover unit 300. The first dispersion guider 330 may primarily disperse the flame or gas G and guide the flame or gas G toward the second dispersion guider 350.

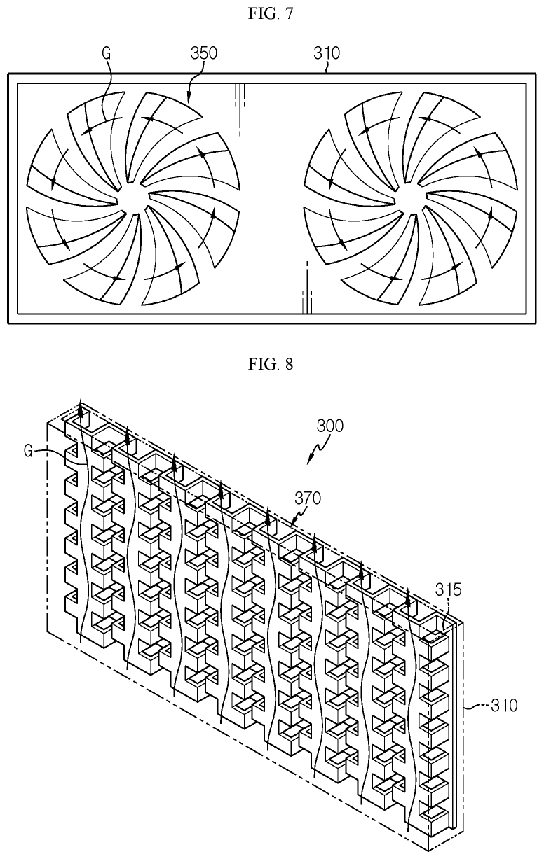

Referring to FIG. 7, after that, the flame or gas G may be, secondarily, guided and dispersed while rotating through the second dispersion guider 350 of a whirlwind shape. At this time, the second dispersion guider 350 may absorb the flame length of the flame or gas G. In addition, the second dispersion guider 350 may lower the flame or gas temperature of the flame or gas G.

Referring to FIG. 8, after that, the flame or gas G may pass through the directional guider 370, tertiarily. As the flame or gas G passes through the directional guider 370, the gas pressure may decrease due to the differential pressure, and the flame or gas temperature of the flame or gas G may be lowered. In addition, the directional guider 370 may guide the flame or gas G toward the discharge hole 315.

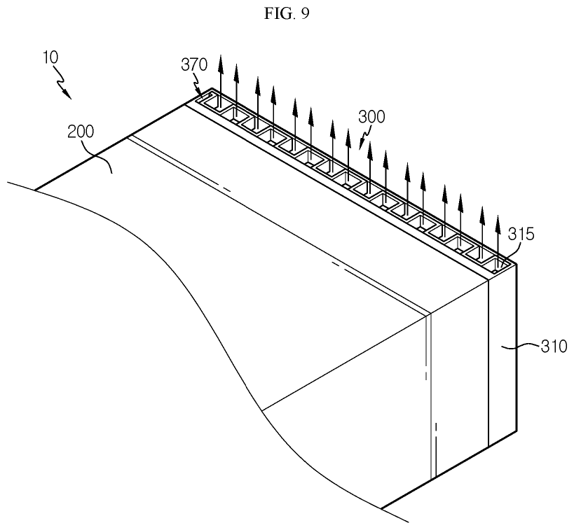

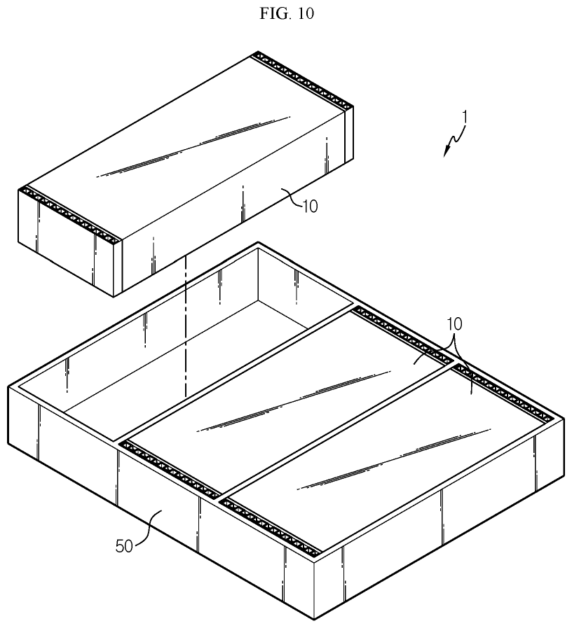

Referring to FIG. 9, the flame or gas may be finally discharged out of the battery module 10 through the discharge hole 315 of the end cover unit 300.

As described above, in the battery module 10 according to this embodiment, when a flame or gas is generated in at least one battery cell 110 among the battery cells 110 of the battery cell assembly 100 due to an abnormal situation, the flame or gas may be dispersed and guided in three steps through the end cover unit 300 to be discharged out of the battery module 10.

Accordingly, in the battery module 10 according to this embodiment, it is possible to effectively prevent dangerous situations such as thermal runaway that may be caused by increasing the temperature of the adjacent battery cells 110 due to the flame or gas G.

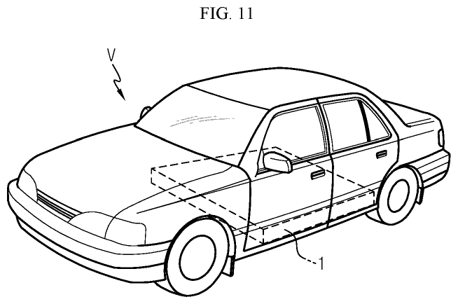

FIG. 10 is a diagram for illustrating a battery pack according to an embodiment of the present disclosure, and FIG. 11 is a diagram for illustrating a vehicle according to an embodiment of the present disclosure.

Referring to FIGS. 10 and 11, a battery pack 1 may include at least one battery module 10 according to the former embodiment and a pack case 50 for packaging the at least one battery module 10.

The battery pack 1 may be provided to a vehicle as a fuel source of a vehicle V. As an example, the battery pack 1 may be provided to an electric vehicle, a hybrid electric vehicle, and various other-type vehicles V capable of using the battery pack 1 as a fuel source.

In addition, the battery pack 1 may be provided in other devices, instruments or facilities such as an energy storage system using a secondary battery, in addition to the vehicle V.

As described above, the battery pack 1 of this embodiment and devices, instruments or facilities such as a vehicle, which have the battery pack 1, include the battery module 10 as described above, and thus it is possible to implement a battery pack 1 having all the advantages of the battery module 10 described above, or devices, instruments, facilities or the like such as a vehicle, which have the battery pack 1.

According to various embodiments as described above, it is possible to provide a battery module 10, which may prevent thermal runaway when a flame or gas is generated inside a module housing 200, and a battery pack 1 and a vehicle V including the battery module 10.

While the embodiments of the present disclosure have been shown and described, it should be understood that the present disclosure is not limited to the specific embodiments described, and that various changes and modifications can be made within the scope of the present disclosure by those skilled in the art, and these modifications should not be understood individually from the technical ideas and views of the present disclosure.

1. A battery module, comprising:
a battery cell assembly including a plurality of battery cells;
a module housing configured to accommodate the battery cell assembly; and
an end cover coupled to the module housing,
wherein when a flame or gas is generated inside the module housing, the end cover is configured to disperse the flame or gas and guide the flame or gas in a predetermined direction.

2. The battery module according to claim 1, wherein the end cover is provided at ends of the module housing and guides the flame or gas in the module housing to an upper side of the ends of the module housing.

3. The battery module according to claim 2, wherein the end cover includes a cover body mounted at the ends of the module housing, and
wherein the cover body has a discharge hole that is opened toward an upper side of the cover body to discharge the flame or gas.

4. The battery module according to claim 3, wherein the end cover includes:
a first dispersion guider provided to the cover body and configured to primarily disperse the flame or gas; and
at least one second dispersion guider disposed to face the first dispersion guider and configured to secondarily disperse the flame or gas.

5. The battery module according to claim 4, wherein the first dispersion guider is disposed to face the battery cell assembly.

6. The battery module according to claim 4, wherein the first dispersion guider is a mesh member made of a metal material.

7. The battery module according to claim 4, wherein the at least one second dispersion guider is configured to communicate with the discharge hole.

8. The battery module according to claim 4, wherein the at least one second dispersion guider has a rib structure of a whirlwind shape.

9. The battery module according to claim 4, wherein the end cover includes a directional guider disposed to face the second dispersion guider and configured to guide a discharge direction of the flame or gas.

10. The battery module according to claim 9, wherein the directional guider is configured to communicate with the discharge hole and guide the flame or gas toward the discharge hole.

11. The battery module according to claim 9, wherein the directional guider includes at least one offset fin.

12. A battery pack, comprising:
at least one battery module as defined in claim 1; and
a pack case configured to package the at least one battery module.

13. A vehicle, comprising at least one battery pack as defined in claim 12.

14. The battery module according to claim 4, wherein the directional guider is formed by a plurality of first rows alternately stacked with a plurality of second rows in a vertical direction, each of the plurality of first rows and the plurality of second rows formed in the shape of a square wave, with the second row offset in a horizontal direction relative to the first row.
